(19) United States
(12) Patent Application Publication
(10) Pub. No.: US 2011/0185865 A1
(43) Pub. Date: Aug. 4, 2011

(54) Apparatus for slicing food products

(75) Inventor: Guenther Weber, Gross Nemerow (DE)

(73) Assignee: Weber Maschinenbau GmbH Breidenbach, Breidenbach (DE)

(21) Appl. No.: 12/970,530

(22) Filed: Dec. 16, 2010

(30) Foreign Application Priority Data
Dec. 21, 2009 (DE) 102009059856.1
Mar. 12, 2010 (DE) 102010011172.4

(51) Int. Cl. B26D 7/06; B26D 1/157; B26D 5/02

(52) U.S. Cl. 83/13; 83/401

(57) ABSTRACT

An apparatus for slicing food products includes a product feed which is configured to convey at least one product along a direction of advance through a cutting plane in which at least one cutting blade moves, in particular in a rotational and/or orbital manner, to cut slices from the product, wherein a spacing can be established between the cutting blade and the product for a blank cut phase in which the cutting blade continues to move, but does not cut any slices from the product in so doing. The product feed is configured to continue to convey the product along the direction of advance during the blank cutting phase.

The invention relates to an apparatus for slicing food products, in particular to a high-performance slicer, having a product feed which is configured to convey at least one product along a direction of advance through a cutting plane in which at least one cutting blade moves, in particular in a rotational and/or orbital manner, to cut slices from the product, wherein a spacing can be established between the cutting blade and the product for a blank cutting phase in which the cutting blade continues to move, but does not cut any slices from the product in so doing.

Such apparatus are generally known and serve to cut food products such as sausage, meat and cheese into slices at high speed. Typical cutting speeds are between several hundred to some thousands of cuts per minute. Modern high-performance slicers differ inter alia in the design of the cutting blade as well as in the manner of the rotary drive for the cutting blade. So-called scythe-like blades or spiral blades rotate about an axis of rotation, with this axis of rotation itself not carrying out any additional movement. Rotating circular blades, in contrast, additionally orbit a further axis spaced apart from the axis of rotation. Which blade type or which type of drive is to be preferred depends on the respective application.

The above-mentioned high cutting speeds make it necessary—and this applies independently of the type of blade and of the type of drive—that, with a portion-wise slicing of products, so-called blank cuts are carried out in which the blade continues to move, i.e. carries out its cutting movement, but does not cut into the product in so doing, but rather cuts into space so that temporarily no slices are cut from the product and these cutting breaks can be used to transport away a portion formed with the previously cut off slices, for example a slice stack or slices arranged overlapping. The time elapsing between two slices cut off after one another is not sufficient for a proper transporting away of the slice portions from a specific cutting performance or cutting speed onward. The length of these blank cutting phases or cutting breaks and the number of blank cuts per cutting break are dependent on the respective application.

It is not sufficient in most cases on the carrying out of blank cuts simply temporarily to stop the feed of the product to prevent the cutting off of slices. With products having a soft consistence, it namely regularly occurs that after the stopping of the product feed, relaxation effects come into force, whereby the front product end moves beyond the cutting plane and thus enters into the active zone of the cutting blade. The consequence is an unwanted cutting off of so-called product snippets or product scraps. Such a formation of scraps can generally also occur with products of a solid consistence. A spacing between the cutting blade and the product can therefore be established as a measure for avoiding a formation of scraps, that is the cutting blade can e.g. be retracted somewhat from the front product end. Alternatively, the product can also be moved away from the cutting blade. Both solution approaches have the consequence that there is a sufficiently large spacing between the front product end and the cutting blade to preclude a formation of scraps.

Measures for avoiding a formation of scraps on the carrying out of blank cuts are known, for example, from the documents EP 0 289 765 A1, DE 42 14 264 A1, EP 1 046 476 A2, DE 101 147 348 A1 and DE 154 952. The product advance is basically stopped during the blank cutting phase in the solutions of the prior art, i.e. the conveying of the product along the direction of advance is temporarily interrupted. On termination of the blank cutting phase, that is when the product and the cutting blade are again led toward one another, the product advance is again set into motion. The problem is present in this respect that irregularities in the movement of the front product end can occur, which is expressed in a reduced cutting quality.

It is therefore an object of the invention to provide a possibility which can be realized with a justifiable effort to avoid a degradation of the cutting quality in a slicing apparatus of the initially named kind despite repeating blank cutting phases.

This object is satisfied by the features of claim 1.

The invention takes the recognition into account that one cause for the losses of cutting quality caused by blank cuts could lie in the fact that the static friction first has to be overcome on each new setting into motion of the product advance, which temporarily sets an increased mechanical resistance against the driving components of the product feed. After the transition into the dynamic friction phase, this resistance quickly drops and can result in a short-term acceleration of the product. Depending on the consistence of the product as well as on the number, frequency and duration of the blank cutting phases, irregularities in the product feed can thus arise which can ultimately result in a degradation of the cutting quality.

The product feed is therefore configured in accordance with the invention to continue to convey the product along the direction of advance during the blank cutting phase. It has namely been recognized in accordance with the invention that the repeated interrupting and setting back into motion of the product advance is disadvantageous with respect to the cutting results. It has furthermore been recognized that a stopping of the product conveying in the direction of advance during the blank cutting phase is not absolutely necessary. It could thus, for example, be acceptable in specific applications to cut off a thicker product slice after every blank cutting phase. If this should not be desired, there is the possibility not to stop the product, but rather only to reduce the speed of advance, as will be explained in even more detail in the following. Due to the omission of the repeated acceleration and deceleration phases for the product as well as by avoiding a periodic sequence of static friction phases and dynamic friction phases, a substantially more stable and more uniform operation of the cutting apparatus is made possible, which in particular provides significant advantages with respect to the cutting quality with fast-working high-performance slicers.

In accordance with an embodiment of the invention, the product feed is configured to convey the product along the direction of advance at a reduced blank cutting speed during the blank cutting phase. The product conveying speed is therefore reduced with respect to the then current value at the start of the blank cutting phase. This reduction of the product conveying speed to the blank cutting speed takes place independently of the fact that the product conveying speed can also be subjected to fluctuations during normal cutting operation. A control can, for example, provide that product slices of equal weight are always cut off despite the change in the size of the cross-sectional surface of the product in that the conveying speed is continuously adapted accordingly during the slicing of the product. The reduction in speed is to be seen with respect to the then current value of the normal speed or with respect to an average value for the normal speed in such an application. The extent of the reduction in speed can be selected within wide ranges in accordance with the respective application requirement since it is sufficient in accordance with the invention to prevent a complete halting or stopping of the product to preclude static friction effects.

The blank cutting speed can be selected in dependence on the duration of the blank cutting phase and/or on the size of the spacing between the cutting blade and the product. The blank cutting speed can in particular be selected the smaller, the longer the duration of the blank cutting phase or the greater the spacing between the cutting blade and the product. It can thereby be ensured that no undesirably thick product slices are cut off on the reapproach of the cutting blade and the product after the termination of the blank cutting phase.

An embodiment of the invention provides that the cutting blade is movable relative to the product for the establishing of the spacing for the blank cutting phase.

In this respect, a cutting head can be provided which includes the cutting blade, which is movable as a whole for establishing the spacing for the blank cutting phase and which is adjusted accordingly. This variant has inter alia the advantage that a bearing required for a rotation of the cutting blade is not affected by the adjustment movement. It is thus not necessary for the practical implementation of the invention to develop special cutting heads since the invention can be used in conjunction with conventional cutting heads which do not allow an adjustment movement of the blade or of the blade shaft without an adjustment movement of the cutting head as a whole.

The term cutting head is to be understood widely in that the size or the extent of the unit adjustable as a whole is not fixed hereby. Depending on the specific embodiment of the slicing apparatus, a drive motor providing the rotary drive of the cutting blade can in particular either belong to the cutting head and can thus be moved together with the cutting blade and the other components or cannot take part in this movement. The drive means between a drive motor which is stationary in this respect, on the one hand, and a cutting blade or blade shaft, on the other hand, can in this case be designed so that they permit the adjustment movement. The cutting head can furthermore only include a so-called blade head which can in particular include the cutting blade together with the holder and transmission or the blade head and a so-called blade head housing which at least partly surrounds the blade head and which can include the drive motor providing the rotary drive for the cutting blade, with the latter, however, not being compulsory. It must also be taken into account in this connection that a maximum adjustment path of no more than 5 to 10 mm is sufficient for the situations relevant in practice in which an adjustment of the cutting blade is required or desired, with in many cases the maximum required adjustment paths even being less than 5 mm. It is in particular sufficient for the carrying out of scrap-free blank cuts if a spacing of a few millimeters is established between the cutting blade and the front product end.

Alternatively, at least a part of the product feed can be movable relative to the cutting blade for establishing the spacing for the blank cutting phase. For example, a product support or a carriage-like part of the same could be moved relative to the cutting blade or the product feed as a whole could be moved away from the cutting blade for carrying out blank cuts. The manner in which the spacing apart of the product and the cutting blade ultimately takes place, that is by movement of the cutting blade or by movement of a part of the product feed, is left up to the respective application and can in particular be selected in dependence on the type of blade or on the arrangement of the product feed. In common applications with a high cutting speed, the establishing of the spacing between the product and the cutting blade for a blank cutting phase should take place within a few milliseconds starting from the regular cutting operation.

In accordance with a further embodiment, the product feed includes a product support on which the product lies and/or a conveying means which in particular engages at the rear product end and/or at a side of the product, with the product support and/or the conveying means being movable relative to the cutting blade for establishing the spacing for the blank cutting phase. The product can, for example, lie on a displaceable carriage which is retracted from the cutting blade by a retraction stroke for carrying out blank cuts. Alternatively, the product could also lie on a belt conveyor which moves the product against the direction of advance for carrying out blank cuts. The conveying means can e.g. be driven claws which engage at the rear product end and convey the product along the direction of advance on the product support.

A further embodiment of the invention provides that the product lies on a product support and is movable relative to the product support by means of a conveying means in particular engaging at the rear product end and/or at a side of the product, with the product support being movable relative to the cutting blade for establishing the spacing for the blank cutting phase and with the product being movable relative to the product support by means of the conveying means during the blank cutting phase. The conveying means can therefore be moved away from the cutting blade as a whole by a retraction stroke during the blank cutting phase, but can in this respect continue to convey the product in the direction of advance so that there is always a relative movement between the product and the product support.

It is furthermore proposed in accordance with a further aspect of the invention that an adjustment device for the cutting blade is provided with which the cutting blade is movable between a cutting position and an additional function position, in particular for carrying out blank cuts. Provision is made in this respect that the cutting blade is coupled to the adjustment device at a first region and to a guide at a second region, with the adjustment movement of the cutting blade being fixed by an exciter movement of the adjustment device and by the guide,

and/or provision is made in this respect that the adjustment movement of the cutting blade is configured such that, in the additional function position, the spacing between the cutting blade and a reference plane, which extends parallel to a cutting plane defined by an edge of the cutting blade and in particular lies on the side of the cutting blade adjacent to the product feed, increases as the distance from a plane defined by a product support of the product feed increases,
and/or provision is made in this respect that a drive unit for the cutting blade is adjustable for adjusting the cutting blade, said drive unit including a drive shaft and at least two rotary bearings for the drive shaft which are spaced apart in the direction of the longitudinal axis of the drive shaft, with the one rotary bearing being coupled to the adjustment device and the other rotary bearing being coupled to a guide.

In this respect, the respective adjustment movement of the cutting blade can be a pivot movement or tilt movement or can include a pivot movement or tilt movement.

This aspect is disclosed and claimed both in combination with the subject matters disclosed in the claims and as an independent aspect.

It is accordingly therefore possible to use an adjustment device for the cutting blade in accordance with the above-named aspect to move the cutting blade for carrying out blank cuts, in particular for establishing the spacing between the cutting blade and the product. It can hereby be avoided where necessary that a scrap formation occurs during the blank cutting phase.

The adjustment device does not only serve for producing the adjustment movement, but rather simultaneously provides that the adjustment movement and thus the movement of the cutting blade in space is fixed. The adjustment device and the guide which in particular engage at different regions of the cutting blade can thus together form a positive guide for the cutting blade and can in this manner clearly define its movement in space. It is therefore not necessary to provide, in addition to at least two guides or holders of the cutting blade which may have any form, the adjustment device as a third device which engages at a third region of the cutting blade in order only to set the cutting blade into motion, whereas the fixing of the adjustment movement only takes place by the two or more guides or holders. The adjustment of the cutting blade can therefore be realized in a particularly simple manner in a construction respect.

As already mentioned, provision is made in an embodiment that the adjustment movement of the cutting blade is a pivot movement or tilt movement or includes a pivot movement or tilt movement. The adjustment movement of the cutting blade can therefore be, but does not have to be, a pure pivot movement or tilt movement. The adjustment movement can in particular be a superimposition of two individual movements of which the one is preset by the guide and the other is preset by the adjustment device.

The first region of the cutting blade coupled to the adjustment device can—viewed in the product feed direction—be disposed before the second region of the cutting blade coupled to the guide.

The guide for the cutting blade can include a pivot mount. The guide preferably includes at least one rod and/or lever, in particular at least one pair of rods and/or levers which are respectively pivotally connected to the cutting blade, on the one hand, and to a base, on the other hand. The base is in particular a cutting head housing. Provision is in particular made in this respect that the pivotal connection to the base is disposed above the pivotal connection to the cutting blade.

The adjustment device includes an eccentric drive in a preferred embodiment. Alternatively, the adjustment device can include a linear drive which is in particular a spindle drive or a cylinder-in-piston arrangement.

In a possible embodiment of the invention, the cutting blade is pivotably suspended at the second region and is deflectably held at the first region.

The adjustment device and/or the guide can be coupled to a rotary bearing for a drive shaft.

The drive shaft can be a component of a drive unit which is adjustable and hereby effects the adjustment of the cutting blade. The drive unit can in turn be a component of a blade head including the cutting blade. Alternatively, the drive unit can support a blade head which is a scythe-like blade head for a scythe-like blade rotating about the blade axis or a circular blade head for a circular blade rotating about the blade axis and orbiting the center axis in a planetary manner. The adjustable drive unit can in this respect therefore be used universally for different types of blade heads.

Provision can therefore generally be made that a drive unit supporting the cutting blade, a blade holder to which the cutting blade is replaceably attachable and/or a blade head is adjustable for adjusting the cutting blade.

In a particular embodiment, the drive unit includes a drive shaft and at least two rotary bearings for the drive shaft which are spaced apart in the direction of the longitudinal axis of the drive shaft. Provision can be made in this respect that the one rotary bearing is coupled to the adjustment device and the other rotary bearing is coupled to the guide. Protection is also independently claimed for this principle, which will be looked at in even more detail in the following.

In accordance with a further development, a blade head is adjustable as a whole by means of the adjustment device, with the blade head preferably including a blade holder to which the cutting blade is replaceably attachable and at least one rotary bearing for the movement of the cutting blade about the blade axis and/or about the center axis. The blade head can in turn be a scythe-like blade head for a scythe-like blade rotating about the blade axis or a circular blade head for a circular blade orbiting the blade axis and orbiting the center axis in a planetary manner.

It is furthermore proposed that a stationary rack is provided, with a blade head as a whole or a blade holder to which the cutting blade is replaceably attachable being adjustable relative to a carrier fixed to the rack. The carrier can be arranged at or in a cutting head housing. The carrier can also be the cutting head housing itself.

In a further particular embodiment, the adjustment movement of the cutting blade is designed such that, in the additional function position of the cutting blade, the spacing between the cutting blade and a reference plane, which extends parallel to a cutting plane defined by an edge of the cutting blade located in the cutting position, increases as the distance from a plane defined by a product support of the product guide increases. The cutting blade can in this respect be tilted forwardly so-to-say. The circumstance can thereby be taken into account that, with an advance of the product taking place continuously during the slicing in a manner familiar to the skilled person, a front product section is present which projects beyond the cutting plane, which is at least approximately wedge-shaped and which would be cut off from the product in an unwanted manner without an adjustment of the cutting blade if the product advance is temporarily stopped—for example for carrying out blank cuts. The adjustment movement of the cutting blade can be adapted to this phenomenon such that the cutting blade is pivoted or tilted in accordance with this wedge shape, i.e. the cutting blade is adjusted as is just required for an avoidance of scrap formation. Protection is also independently claimed for this principle, which will be looked at in even more detail in the following.

In this respect, the adjustment movement of the cutting blade can be designed such that the cutting blade is at least approximately pivotable or tiltable about a point, which is in particular imaginary, which is disposed in a plane defined by the product support or beneath it.

A rotary drive can be associated with the cutting blade.

A rotary drive associated with the cutting blade can be arranged fixed to the rack or can be able to make a compensation movement adapted to the adjustment movement of the cutting blade.

The rotary drive can be arranged together with a blade head at or in a cutting head housing fixed to the rack.

Provision can furthermore be made that the rotary drive cooperates with a blade head carrying out the adjustment movement as a whole or with a part of the blade head carrying out the adjustment movement, in particular with a blade holder, in particular via at least one drive belt.

As already mentioned above, provision is made in accordance with a further aspect of the invention claimed dependently and independently that the adjustment movement of the cutting blade is designed so that, in the additional function position, the spacing between the cutting blade and a reference plane, which extends parallel to a cutting plane defined by an edge of the cutting blade located in the cutting position and is in particular disposed on the side of the cutting blade adjacent to the product feed, increases as the distance from a plane defined by a product support of the product feed increases.

In this respect, the adjustment movement of the cutting blade can be designed such that the cutting blade is at least approximately pivotable or tiltable about a point, which is in particular imaginary, which is disposed in a plane defined by the product support or beneath it.

A further aspect of the invention claimed dependently and independently was likewise already mentioned above according to which a drive unit for the cutting blade is adjustable for the adjustment of the cutting blade, said drive unit including a drive shaft and at least two rotary bearings for the drive shaft which are spaced apart in the direction of the longitudinal axis of the drive shaft, with the one rotary bearing being coupled to the adjustment device and the other rotary bearing being coupled to a guide.

In this respect, the drive unit can support the cutting blade, a blade holder to which the cutting blade is releasably attachable and/or a blade head.

The invention further relates to the use of the apparatus in accordance with the invention for carrying out blank cuts, in particular in the portion-wise slicing of food products, wherein the cutting blade is moved away from the front product for temporarily interrupting the cutting of slices from the product and is moved back again after carrying out one or more blank cuts for restarting the cutting of slices from the product.

The term “additional function” is to be understood such that a function is meant by it which does not relate exclusively to the actual slicing function, that is to the rotary movement or orbital movement of the cutting blade. The additional function is in particular the carrying out of blank cuts in the portion-wise slicing of the products. The additional function can also be a vertical setting or a setting of the dipping depth of the cutting blade, in particular with respect to the product or products to be sliced or the product support, more precisely the avoidance of a scrap formation on blank cuts carried out within the framework of the vertical setting or dipping depth setting. The adjustment movement of the blade therefore takes place as required whenever the additional function should be carried out, with this additional function being able to be carried out—depending on its kind—with a rotating or orbiting cutting blade and/or with a stationary cutting blade.

Provision is made in a preferred embodiment—as already mentioned—that the adjustment movement of the cutting blade is a pivot movement or tilt movement or includes a pivot movement or tilt movement. This has the advantage that the forces required for the adjustment can be kept relatively small. It is furthermore advantageous that no plain bearings or slider bearings are required such as are required in a purely translatory adjustment movement, for example in an axial adjustment movement.

If the adjustment movement is designed so that the cutting blade is no longer aligned parallel to the cutting plane given in the cutting position in the additional function position with the cutting plane defined by the edge of the cutting blade, this is of no significance for the carrying out of blank cuts since the orientation of the cutting blade with respect to the front product end is generally not of importance as long as it is ensured that no scraps are cut from the front product end in that it is e.g. provided that a sufficiently large spacing is present between the cutting blade and the front product end.

The provision of a pivot movement or tilt movement at least as a component of the adjustment movement furthermore has the advantage that a desired spacing between the cutting blade and the front product end can be established particularly fast and also particularly simply in this manner.

The invention also provides a method for slicing food products. In accordance with the invention, at least one product is conveyed by means of a product feed along a direction of advance through a cutting plane in which at least one cutting blade is moved, in particular in a rotating and/or orbiting manner, for cutting slices from the product. A spacing is established between the cutting blade and the product during a blank cutting phase in which the cutting blade continues to move, but no slices are cut from the product in so doing. The product is continued to be conveyed along the direction of advance during the blank cutting phase. The product conveying is therefore not stopped at the start of the blank cutting phase as in the solutions of the prior art. The product conveying can in particular run on continuously.

In accordance with an embodiment, a relative movement is maintained without interruption between the product and a product support on which the product lies during the blank cutting phase. The advantage of this uninterrupted maintenance of the relative movement lies in the avoidance of static friction effects such as occur on a standstill between the product and the product support.

The cutting blade, in particular a cutting head including the cutting blade and movable as a whole for establishing the spacing for the blank cutting phase can be moved relative to the product and/or the product, in particular at least a part of the product guide, can be moved relative to the cutting blade for establishing the spacing for the blank cutting phase. In simplified terms, either the blade can therefore be moved away from the product or the product can be moved away from the blade. It is basically also possible to move away both the blade and the product, that is—contrary to a moving away of only the blade or of only the product—to leave neither the product nor the blade stationary.

In accordance with an embodiment, a product support on which the product lies is moved relative to the cutting blade for establishing the spacing for the blank cutting phase, with the product being moved relative to the product support during the blank cutting phase. The associated conveying means can be moved with the product support relative to the cutting blade. The relative movement between the product and the product support caused by the conveying means therefore remains uninfluenced by the relative movement between the product support and the cutting blade.

The product can be conveyed along the direction of advance at a reduced blank cutting speed during the blank cutting phase. The blank cutting speed can in this respect, as explained above, be selected in dependence on the duration of the blank cutting phase and/or on the size of the spacing between the cutting blade and the product.

In accordance with an embodiment, the blank cutting speed is selected such that the product is conveyed during the blank cutting phase by a measure which corresponds to the desired thickness of the slice to be cut off first after the blank cutting phase. It is achieved by this measure that the thickness of the product slices always remains the same despite the repeated carrying out of blank cuts even though the product advance is never stopped or interrupted.

It is furthermore proposed in accordance with a further aspect of the invention that, on the movement, an adjustment device for the cutting blade is provided with which the cutting blade is movable, in particular for carrying out blank cuts, between a cutting position and an additional function position.

Provision is made in this respect that the cutting blade is coupled to the adjustment device at a first region and to a guide at a second region and, for the adjustment of the cutting blade, its adjustment movement is fixed by an exciter movement of the adjustment device and by the guide, and/or provision is made in this respect that the adjustment movement of the cutting blade is carried out such that, in the additional function position, the spacing between the cutting blade and a reference plane, which extends parallel to a cutting plane defined by an edge of the cutting blade and is in particular disposed on the side of the cutting blade adjacent to the product feed, increases as the distance from a plane defined by a product support of the product feed increases,

and/or provision is made in this respect that a drive unit for the cutting blade is adjusted for adjusting the cutting blade, said drive unit including a drive shaft and at least two rotary bearings for the drive shaft which are spaced apart in the direction of the longitudinal axis of the drive shaft, with the one rotary bearing being coupled to the adjustment device and the other rotary bearing being coupled to a guide.

This aspect is disclosed and claimed both in combination with the subject matters disclosed in the claims and as an independent aspect.

It is accordingly also possible that an adjustment device for the cutting blade in accordance with the above-named aspect is used to move the cutting blade for carrying out blank cuts, in particular for establishing the spacing between the cutting blade and the product. It can hereby be avoided where necessary that a scrap formation occurs during the blank cutting phase.

Further embodiments are set forth in the dependent claims, in the description and in the enclosed drawing.

The invention will be described in the following by way of example with reference to the drawing.

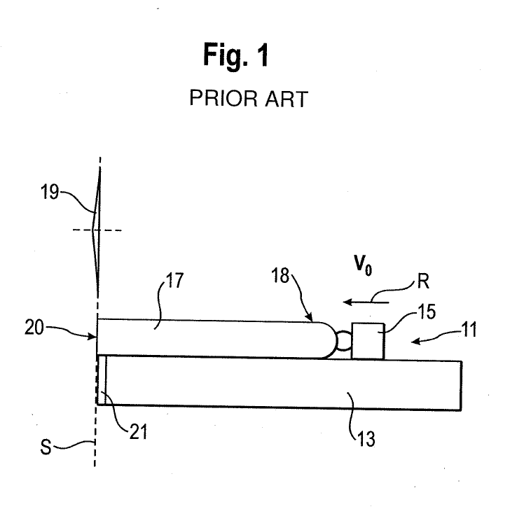

FIG. 1 schematically shows a slicing apparatus in accordance with the prior art;

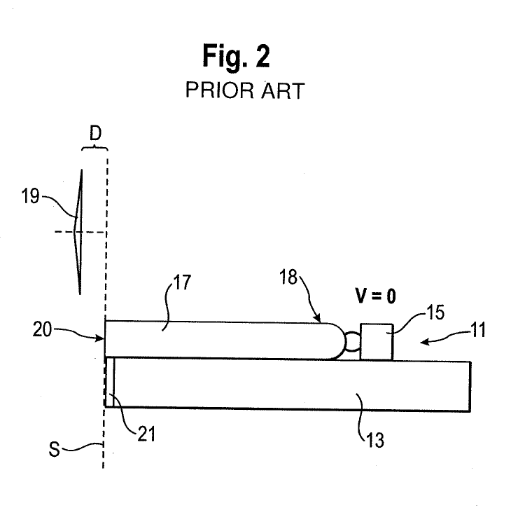

FIG. 2 shows the slicing apparatus in accordance with FIG. 1 during a blank cutting phase;

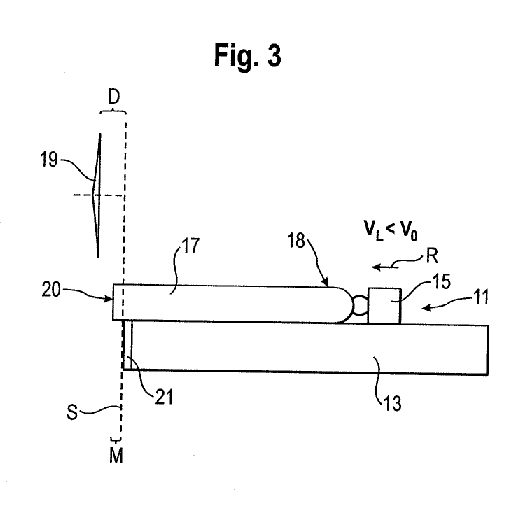

FIG. 3 shows a slicing apparatus in accordance with the invention during a blank cutting phase;

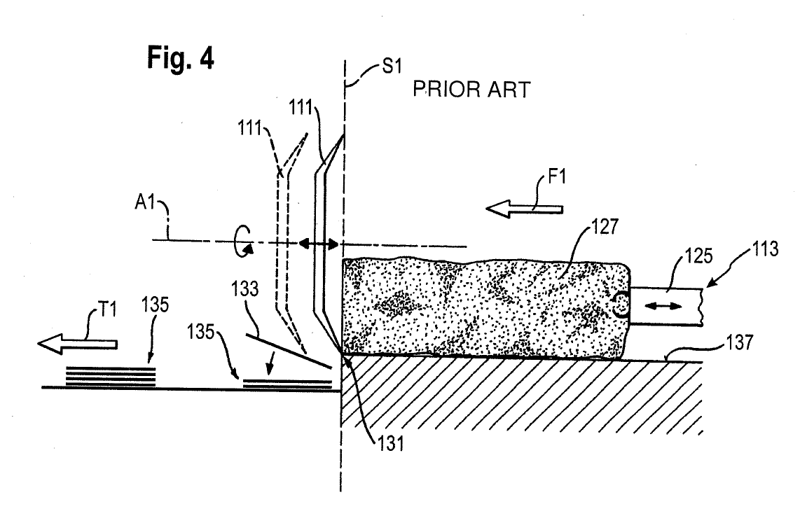

FIG. 4 shows a schematic representation of the functional principle of a slicer having an axially adjustable cutting blade in accordance with the prior art;

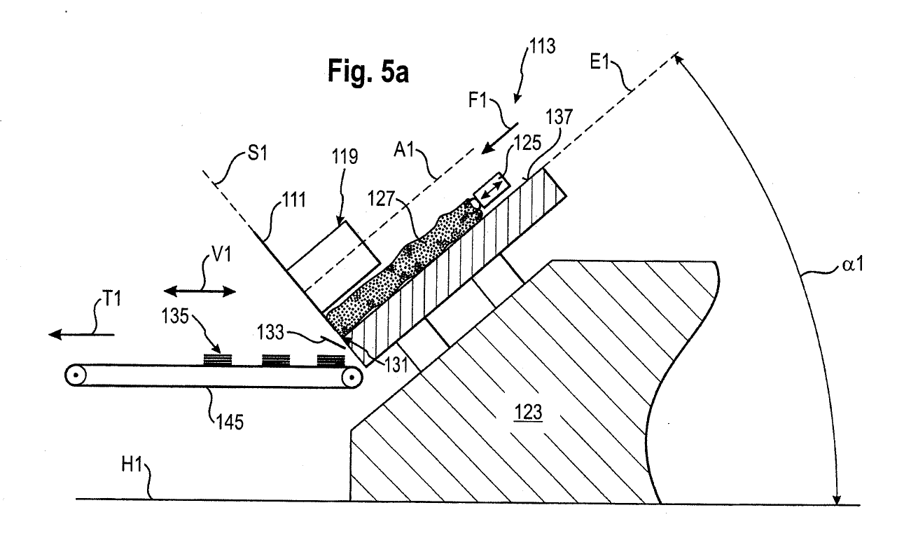

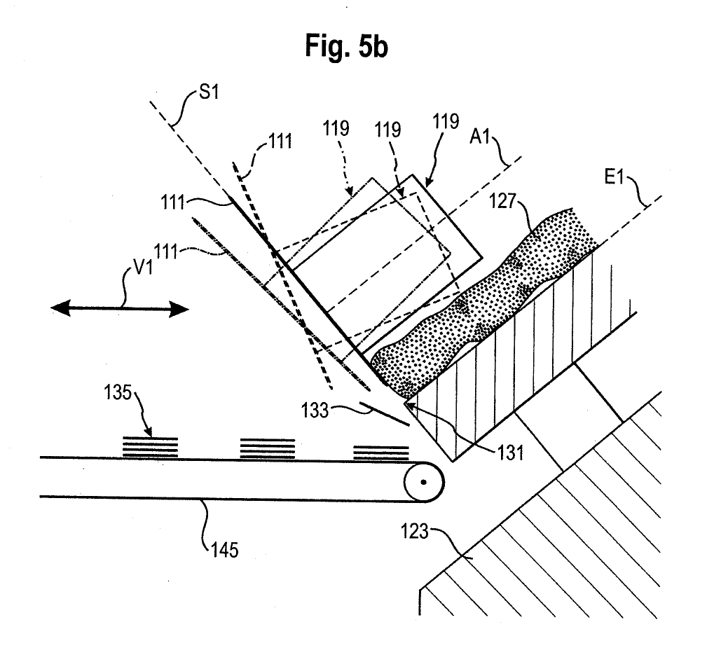

FIGS. 5a and 5b each show a schematic side view (FIG. 5b shows an enlarged section of FIG. 5a) of a slicer in accordance with the invention having a tiltable cutting blade;

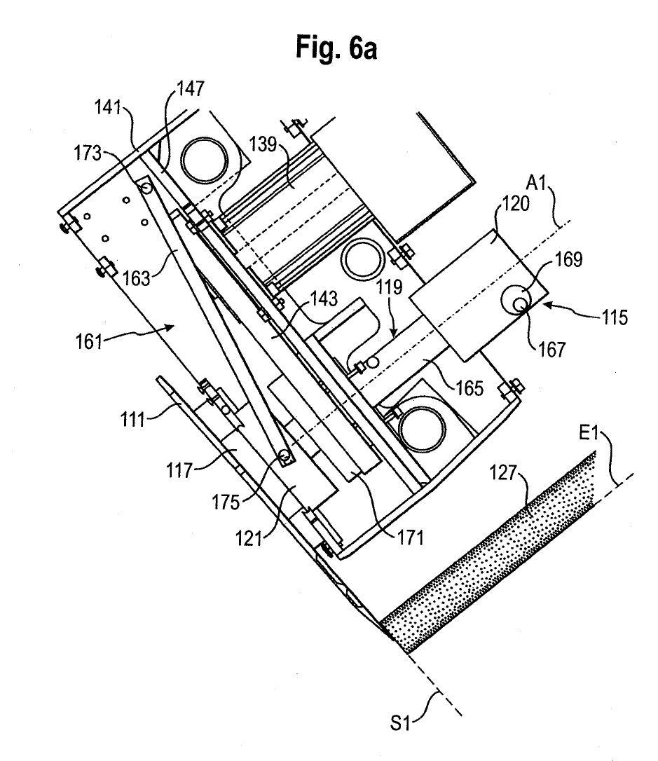

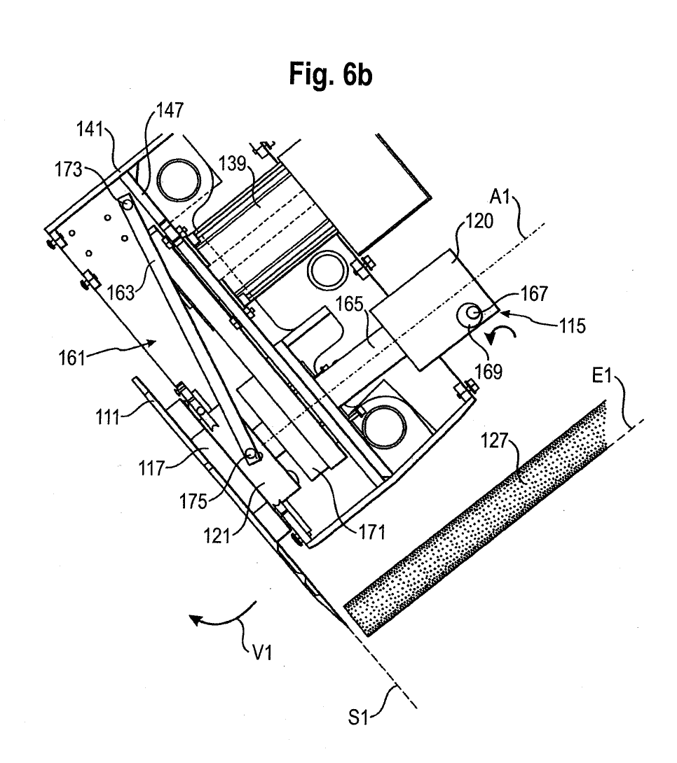

FIGS. 6a and 6b each schematically show a side view of a possible specific embodiment of a cutting head of a slicer in accordance with the invention in a cutting position (FIG. 6a) and in a blank cutting position (FIG. 6b); and

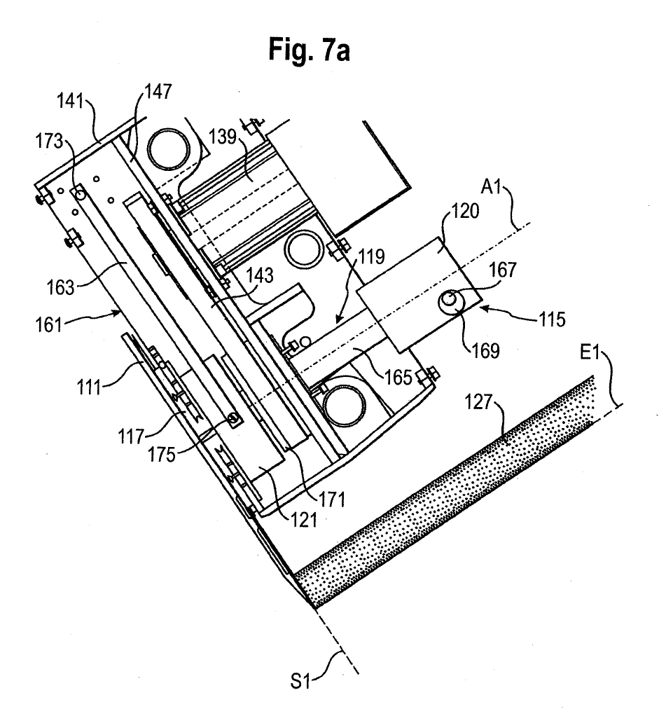

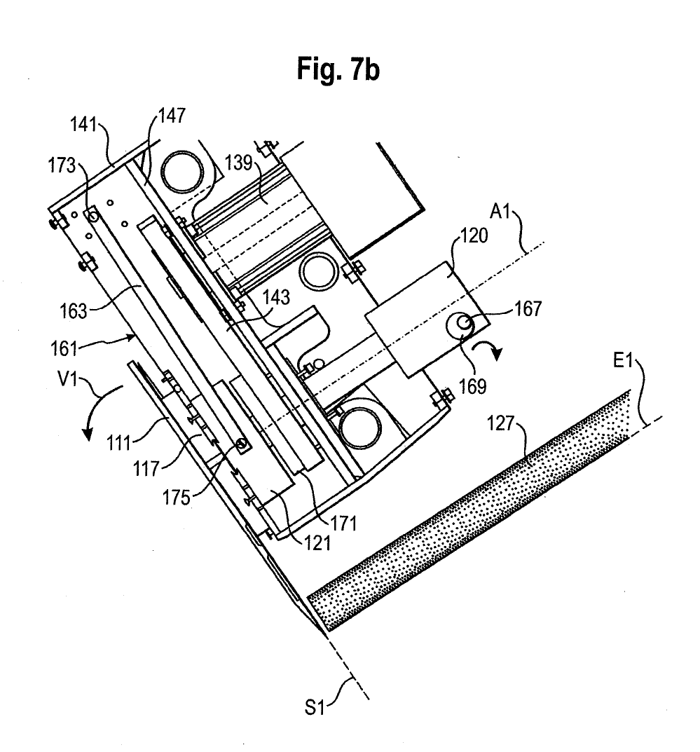

FIGS. 7a and 7b schematically show a side view of a further possible specific embodiment of a cutting head of a slicer in accordance with the invention in a cutting position (FIG. 7a) and in a blank cutting position (FIG. 7b).

In the following different reference numerals are also used for those parts and terms which actually correspond to one another.

The embodiments explained in the following can either be combined with one another or can each be separately realized.

A cutting apparatus such as is known from the prior art is shown in FIG. 1. The cutting apparatus includes a product feed 11 which includes a product support 13 and a conveying means 15. A product 17 lies on the product surface 13 and the conveying means 15 engages at its rear end to convey the product 17 on the product support 13 along a direction of advance R through a cutting plane S at a conveying speed V₀. As mentioned above, the conveying speed V₀ can be an average value or base value by which the actual value fluctuates e.g. for adapting to a varying cross-sectional shape of the product. The product feed 11 can have further components for guiding and holding the product such as lateral guide rails or holding-down devices which are not shown in FIG. 1 for reasons of simplicity. The conveying means 15 in the example shown is a pair of driven claws which push the product 17 toward the cutting plane S.

A cutting blade 19 orbits in a planetary manner in the cutting plane S, with alternatively a cutting blade, in particular a scythe-like blade, also being able to be used which does not orbit in a planetary manner, but only rotates. The cutting blade 19 cooperates with a cutting edge 21 which is provided at the front end of the product support 13, here the cutting edge 21 defining the cutting plane S, and which acts as a counter-blade to cut slices from the conveyed product 17.

The cut-off product slices fall onto a transport device likewise not shown in FIG. 1, for example onto a movable table or onto a band conveyor or belt conveyor, and are transported away portion-wise. They can, for example, be fed to a packaging machine connected downstream. To transport a completed portion of cut-off product slices away, a blank cutting phase is provided with the cutting apparatus in which the cutting blade 19 continues to move, but does not cut any slices from the product 17 in so doing.

A spacing D between the cutting blade 19 and the front end 20 of the product 17 is established for the blank cutting phase, as can be seen from FIG. 2. In the example shown, the cutting blade 19 is moved away from the product feed 11 for carrying out blank cuts. Alternatively, a reverse procedure could also be followed, that is the product feed 11 could be retracted together with the product support 13 and the conveying means 15 from the cutting blade. The retraction stroke which corresponds to the spacing D is shown in exaggerated form for illustration in FIG. 2. As stated above, it usually amounts to only a few millimeters. In addition, in the prior art, the product advance is stopped or halted in that the conveying means 15 is accordingly controlled. The conveying speed V₀ thus amounts to zero during the blank cutting phase.

In contrast, in accordance with FIG. 3, which shows a slicing apparatus in accordance with an embodiment of the invention and in which the same reference numerals are used as in FIGS. 1 and 2, the product 17 continues to be conveyed by the conveying means 15 during the blank cutting phase. Apart from the further conveying of the product 17 during the blank cutting phase in accordance with the invention, the slicing apparatus in accordance with FIG. 3 has the same features as the apparatus of the prior art described in connection with FIGS. 1 and 2.

The conveying during the blank cutting phase takes place at a blank cutting speed V_{L} which is reduced with respect to the original conveying speed V₀. This is achieved in that the conveying means 15 is controlled accordingly by a control device not shown in FIG. 3. A relative movement is therefore maintained without interruption between the product 17 and the product support 13 during the blank cutting phase. The value of the blank cutting speed V_{L} is selected such that the product 17 is conveyed during the blank cutting phase by a conveying measure M which corresponds to the desired thickness of the product slice to be cut off first after the blank cutting phase. The product slice thickness then remains constant even though a constant product advance takes place so that no negative influence on the product slice thickness is therefore exerted by the blank cutting phase. This means that the blank cutting speed V_{L} is selected the smaller, the more blank cuts are to be carried out in the blank cutting phase or the larger the spacing D is.

Since a standstill does not occur between the product 17 and the product support 13 in connection with blank cuts at any time in accordance with the invention, problems are avoided which are caused by static friction.

The moving back of the cutting blade 19 for terminating the blank cutting phase in particular takes place in time coordination with the cutting movement of the cutting blade, for example with its angular position, to ensure a problem-free restart of cutting operation.

FIG. 4 shows in a schematic side view a high-performance slicer known from the prior art which serves to cut food products 127 such as meat, sausage, ham or cheese into slices. During the cutting procedure, the product 127 lies on a product support 137 and is moved along a product feed direction F1 in the direction of a cutting plane S1 by means of a product feed 113. The product feed direction F1 extends perpendicular to the cutting plane S1. As mentioned in the introduction part, such slicers are also known in which the angle between the product feed direction and the cutting plane is different from 90°. Only the already mentioned product support 137 as well as a so-called product holder 125 are shown of the product feed 113 in FIG. 4, said product holder engaging with claws or grippers into the rear end of the product 127 and being drivable by drive means not shown in and against the product feed direction F1, as is indicated by the double arrow.

The cutting plane S1 is always defined by the edge of the cutting blade 111 independently of the operating state of the cutting blade 111. The cutting blade 111 cooperates during the slicing operation with a cutting edge 131 which is also called a counter-blade and which forms the front termination of the product support 137. In practice, the cutting edge is usually a separate, replaceable component, e.g. made from plastic or steel, which is not shown here for reasons of simplicity.

As mentioned in the introduction part, the cutting blade 111 can be a so-called circular blade which both orbits a center axis in a planetary manner and rotates about its own blade axis. Alternatively, the cutting blade 111 can be a so-called scythe-like blade or spiral blade which has a non-circular blade disk having a margin forming the edge and e.g. lying on a spiral track about the blade axis and does not orbit in a planetary manner, but rather only rotates about the blade axis A1. Still other blade types can generally also be provided. The drive for the cutting blade 111 is not shown in FIG. 4.

In order to establish a spacing between the blade 111 and the front end of the product 127 within the framework of an additional function of the slicer, an adjustment device, not shown, is provided which is configured to move the cutting blade 111. As indicated by the double arrow in FIG. 4, it is known from the prior art to move the cutting blade parallel to its axis of rotation (blade axis) A1. For this purpose, the cutting blade 111 can be displaceably mounted parallel to the axis of rotation A1. In connection with the carrying out of blank cuts, with a disengaged blade 111 (indicated by a broken line in FIG. 4), that is with a blade 111 spaced apart from the front product end, scrap formation or snippet formation is reliably avoided.

With a portion-wise slicing of the product 127, as is shown in FIG. 4, the cut off product slices 133 form portions 135 which are shown as slice stacks in FIG. 4. As soon as a portion 135 is completed, this portion 135 is transported away in a direction T1. So that sufficient time is available for the transporting away of the finished slice portions 135, the mentioned blank cuts are carried out until the start of the formation of the next portion 135, for which purpose the product feed, also called a product advance, (that is here the product holder 125) is continued or stopped, on the one hand, and the cutting blade 111 is moved, on the other hand, by means of the mentioned adjustment device into the position shown by broken lines in FIG. 4.

FIG. 5a schematically shows a slicer in accordance with the invention in a side view. The product feed 113 is shown in that position in which the product 127 is being sliced. The product feed 113 can be pivoted into an at least approximately horizontal position for loading with a new product. In the cutting position shown, however, the product feed 113 and thus the product feed direction F1 is inclined with respect to the horizontal H1, and indeed by an angle α1 which amounts, for example, approximately to 40°. Since in this embodiment the product feed direction F1 and thus the plane E1 defined by the product support 137 extends parallel to the blade axis A1 (which is, however, not absolutely necessary—as already mentioned above), the angle of inclination α1 is here drawn between the horizontal H1 and the plane E1 of the product support 137. The invention can, however, also be used in conjunction with such slicers in which a product fed in a horizontal or vertical direction is sliced.

In the embodiment shown, the product support 137 represents a slanted plane for the product 127. The advance movement of the product 127 is hereby assisted by the earth's gravitational pull. It is, however, of greater importance that due to the slanted position of the product feed 113, the front product end is not oriented vertically—as would be the case with a horizontally lying product—so that due to the inclination of the front product end, the depositing of the cut-off product slices 133—on a belt 145 for transporting away here—is improved or a usable product depositing is only made possible at all.

Whereas in slicers known from the prior art the cutting blade 111—corresponding to the representation in FIG. 4—is moved parallel to the blade axis A in order, for example, to achieve a spacing between the cutting blade 111 and the front product end for carrying out blank cuts, in accordance with the invention—as FIG. 5b shows with reference to two examples—adjustment movements of the cutting blade 111 are provided in which the orientation of the cutting blade 111 and thus the orientation of the cutting plane S1 defined by the edge of the cutting blade 111 in space is changed.

In FIG. 5b, the cutting position of the blade 111 is shown by solid lines in which the cutting plane S1 and a reference plane defined by the cutting edge 131 coincide, which represents a simplification here to the extent that in practice a small, usually adjustable cutting gap is present between the cutting blade 111 and the cutting edge 131, which does not, however, need to be looked at in more detail here. In accordance with an embodiment, an additional function position is indicated by broken lines in which the cutting blade 111—here as a component of the blade head 119—has undergone an adjustment position, starting from the cutting position, which includes a pivot movement or tilt movement taking place clockwise—with respect to the view of the drawing. In accordance with a further embodiment indicated by chain-dotted lines, the pivot movement or tilt movement of the cutting blade has taken place counter-clockwise.

The invention thus makes possible—depending on its specific embodiment—adjustment movements of the cutting blade or of a blade head including the cutting blade both in the one and in the opposite pivot sense and tilt sense respectively. The invention in particular provides that not only the blade 111 or a blade holder alone, but rather the blade head 119 only indicated schematically here is adjusted as a whole. This will be looked at in more detail in the following in connection with FIGS. 6a and 6b and FIGS. 7a and 7b respectively. The adjustment movement of the blade 111 or of the blade head 119 ultimately takes place relative to a fixed-position frame or rack 123 of the slicer. This will also be looked at in more detail in the following in connection with the named Figures.

FIGS. 6a and 6b show a possible specific embodiment of the invention. The blade head 119 is a scythe-like blade head, i.e. the cutting blade 111 is a scythe-like blade which carries out a rotational movement about a blade axis A1 and does not additionally orbit in a planetary manner.

The blade 111 is replaceably attached to what is here called a blade holder 117 which is also called a blade mount, rotor or blade shaft.

The blade head 119 adjustable as a whole in a manner described in more detail in the following furthermore includes a drive shaft 165 which is rotatably mounted in a front rotary bearing 121 and in a rear rotary bearing 120. The rotational drive of the drive shaft 165 takes place by means of a motor 139 which forms the rotary drive and which cooperates via a drive belt 143 with a belt pulley 171 which is rotationally fixedly attached to the drive shaft 165. The motor 139 is fixedly connected to a wall 147 which is a component of a cutting head housing 141 which is attached to a rack or frame 123 stationary with respect to the adjustment movement of the blade head 119 (cf. FIGS. 5a and 5b). An adjustability of the cutting head housing 141 as a whole in directions which lie in the cutting plane S1 defined by the edge of the blade 111 are furthermore possible relative to the product support (of which here only the plane E1 defined by it is shown here), but are otherwise of no further significance for the subject matter of the invention.

A cover or hood which is connected to the cutting head housing 141 and which surrounds the cutting blade 11 at least partly during the cutting operation is likewise provided, but not shown here.

The blade head 119 is pivotably suspended at the cutting head housing 141 in the front region by means of a lever pair 163 forming a guide 161. The pivotal connection points 173 of the levers 163 at the cutting head housing 141 disposed above and behind the pivotal connection points 175 of the levers 163 at the blade head 119. This suspension of the blade head 119 takes place via its front rotary bearing 121.

The blade head 119 is held at a rear region, namely at the rear rotary bearing 120, by an adjustment device 115 such that the rotary bearing 120 rotatably supporting the drive shaft 165 can be deflected by an exciter movement of the adjustment device 115 for adjusting the blade head 119 and thus the cutting blade 111 relative to the cutting head housing 141. This exciter movement is produced in that a rotationally drivable shaft 167 stationary with respect to the cutting head housing 141 is rotationally fixedly connected to an eccentric part 169 which can rotate in a corresponding mount of the rotary bearing 120.

The suspension or holding of the blade head 119 is designed in this embodiment such that a rotary movement of the eccentric parts 169 by 90° counter-clockwise produced by rotating the shaft 167 (as indicated in FIG. 6b by the arrow) effects an adjustment movement V1 of the blade head 119 and thus of the cutting blade 111 which includes a pivot movement or tilt movement taking place clockwise. The rotary bearing 120—and thus the blade head 119 in its rear region—is moved to the front and downwardly by the exciter movement of the adjustment device 115. In cooperation with the pivotable suspension provided in the front region by the levers 163, the mentioned adjustment movement results which has the consequence that the orientation of the cutting plane S1 defined by the edge of the cutting blade 111 changes with respect to the cutting head housing 141 and thus with respect to the front end of the product 127.

The extent of this tilt of the cutting blade 111 is comparatively small Reference is therefore again made to the blade head 119 shown by dashed lines in FIG. 5 for illustrating this movement.

The embodiment of FIGS. 7a and 7b differs from that of FIGS. 6a and 6b in particular by a different front pivotable suspension of the blade head 119 and a rotary movement in the opposite sense of the shaft 167 of the adjustment device 115 cooperating with the rear rotary bearing 120 via the eccentric part 169.

The pivotal connection points 173 and 175 of the levers 163 lie at least approximately in a plane which extends parallel to the cutting plane S1 of the blade 111 in the cutting position shown in FIG. 7a. The suspension and holding of the blade head 119 in this embodiment are selected such that the rotary movement of the eccentric part 169 by 90° taking place clockwise here has the consequence that the rear rotary bearing 120 of the blade head 119 is moved to the front and upwardly with respect to the cutting head housing 141. The blade head 119 and thus the cutting blade 111 is thus tilted to the front. In the blank cutting position in accordance with FIG. 7b, the spacing between the cutting blade 111 and the original position of the cutting plane S1 given in the cutting position in accordance with FIG. 7a increases as the distance from the plane E1 defined by the product support increases. The position of the pivotal connection points 173 and 175 alone is not decisive for the “rotary sense” of the tilt movement of the cutting blade 111, but rather only one parameter of a plurality of parameters which overall fix the direction and extent of the tilt movement of the cutting blade 111.

The extent of this tilting of the cutting blade 111 is in turn comparatively small so that reference is made to the blade head 119 shown by chain-dotting in FIG. 5b for an illustration of this movement.

By a corresponding adaptation of the suspension and holding of the blade head 119, this adjustment movement can be designed so that the cutting blade 11 is pivoted or tilted at least approximately about a virtual point which is disposed in the plane E1 defined by the product support or beneath it.

The blade head 119 including the adjustment device 115 can be configured, alternatively to the explained embodiments, such that the blade head 119 together with the adjustment device 115 is disposed completely within the cutting head housing 141.

Additional measures which have not previously been mentioned can furthermore be provided in accordance with the invention in order at least partly to compensate the deflection or extension of the drive belt 143 which occurs on the adjustment of the blade head 119 and thus of the belt pulley 171 directly rotationally driven by the drive belt 143. A measure for this purpose can, for example, comprise also moving the rotary drive motor 139, on the adjustment of the blade head 119, in a manner coordinated with the adjustment movement of the blade head 119 such that the effects of the blade head adjustment movement on the drive belt 143 are compensated at least up to a specific degree.

The effect of the belt extension or belt deflection can also be at least largely eliminated by a suitable orientation of the blade head which differs from that in FIGS. 6a and 6b and in FIGS. 7a and 7b respectively.

### REFERENCE NUMERAL LIST

11 product feed
13 product support
15 conveying means
17 product
18 rear product end
19 cutting blade
20 front product end
21 cutting edge
r direction of advance
S cutting plane
V_{L} blank cutting speed
V₀ conveying speed
D spacing
M conveying measure
111 cutting blade
113 product feed
115 adjustment device
117 blade holder
119 blade head
120 rotary bearing
121 rotary bearing
123 rack
125 product holder
127 product
131 cutting edge
133 product slice
135 slice portion
137 product support
139 rotary drive, motor
141 carrier, cutting head housing
143 drive belt
145 belt for transporting away
147 wall
161 guide
163 lever
165 drive shaft
167 shaft
169 eccentric part
171 belt pulley
173 pivotal connection point
175 pivotal connection point
A1 blade axis
F1 product feed direction
S1 cutting plane
T1 transporting-away direction
V1 adjustment movement
H1 horizontal
D1 axis of rotation of the spindle drive
α1 angle of inclination
E1 plane

1. An apparatus for slicing food products (17; 127), in particular a high-performance slicer, comprising
a product feed (11; 113) which is configured to convey at least one product (17; 127) along a direction of advance (R; F1) through a cutting plane (S; S1) in which at least one cutting blade (19; 111) moves, in particular in a rotating and/or orbital manner, for cutting slices from the product (17; 127),
wherein a spacing (D) can be established between the cutting blade (19; 111) and the product (17; 127) for a blank cutting phase in which the cutting blade (19; 111) continues to move, but does not cut any slices from the product (17; 127) in so doing,
characterized in that
the product feed (11; 113) is configured to continue to convey the product (17; 127) along the direction of advance (R; F1) during the blank cutting phase.

2. An apparatus in accordance with claim 1,
characterized in that
the product feed (11; 113) is configured to convey the product (17; 127) along the direction of advance (R; F1) at a reduced blank cutting speed (V_{L}) during the blank cutting phase.

3. An apparatus in accordance with claim 2,
characterized in that
the blank cutting phase (V_{L}) is selected in dependence on at least one of the duration of the blank cutting phase and the size of the spacing (D) between the cutting blade (19; 111) and the product (!7; 127).

4. An apparatus in accordance with claim 1,
characterized in that
the cutting blade (19; 111) is movable relative to the product (17; 127) for establishing the spacing (D).

5. An apparatus in accordance with claim 4,
characterized in that
a cutting head including the cutting blade (19; 111) and movable as a whole for establishing the spacing (D) is provided for the blank cutting phase.

6. An apparatus in accordance with claim 1,
characterized in that
at least a part of the product feed (11; 113) is movable relative to the cutting blade (19; 111) for establishing the spacing (D) for the blank cutting phase.

7. An apparatus in accordance with claim 1,
characterized in that
the product feed (11; 113) includes at least one of a product support (13; 137) on which the product (17; 127) lies and a conveying means (15), with the said at least one of the product support (13; 137) and the conveying means (15) being movable relative to the cutting blade (19; 111) for establishing the spacing (D) for the blank cutting phase.

8. An apparatus in accordance with claim 7,
characterized in that
the conveying means engages at least one of a rear product end (18) and a side of the product

9. An apparatus in accordance with claim 8,
characterized in that
the product (17; 127) lies on the product support (13; 137), with the product support (13; 137) being movable relative to the cutting blade (19; 111) for establishing the spacing (D) for the blank cutting phase and with the product (17; 127) being movable relative to the product support (13; 137) by means of the conveying means (15) during the blank cutting phase.

10. An apparatus in accordance with claim 1,
characterized in that
an adjustment device (115) for the cutting blade (19; 111) is provided with which the cutting blade (19: 111) is movable between a cutting position and an additional function position, in particular for carrying out blank cuts;
wherein the cutting blade (19; 111) is coupled to the adjustment device (115) at a first region and to a guide (161) at a second region and the adjustment movement of the cutting blade (19; 111) is fixed by an exciter movement of the adjustment device (115) and by the guide (161)

11. An apparatus in accordance with claim 1,
characterized in that
the adjustment movement of the cutting blade (19; 111) is designed so that, in the additional function position, the spacing between the cutting blade (19; 111) and a reference plane, which extends parallel to a cutting plane (S; S1) defined by an edge of the cutting blade (19; 111) and which is in particular disposed on the side of the cutting blade adjacent to the product feed, increases as the distance from a plane (E1) defined by a product support (13; 137) of the product feed (11; 113) increases.

12. An apparatus in accordance with claim 1,
characterized in that,
for the adjustment of the cutting blade (19; 111), a drive unit for the cutting blade (19; 111) is adjustable which includes a drive shaft (165) and at least two rotary bearings (120, 121) for the drive shaft (165) which are spaced apart in the direction of the longitudinal axis of the drive shaft (165), with the one rotary bearing (120) being coupled to the adjustment device (115) and the other rotary bearing (121) being coupled to a guide (161).

13. An apparatus in accordance with claim 1,
characterized in that
an adjustment movement of the cutting blade (19; 111) is one of a pivot movement and a tilt movement or includes one of a pivot movement and a tilt movement.

14. A method of slicing food products (17; 127),
characterized in that
at least one product (17; 127) is conveyed along a direction of advance (R; F1) by means of a product feed (11; 113) through a cutting plane (S; S1) in which at least one cutting blade (19; 111) moves, in particular in a rotating and/or orbiting manner, for cutting slices from the product (17; 127);
a spacing (D) is established between the cutting blade (19; 111) and the product (17; 127) during a blank cutting phase in which the cutting blade (19; 111) continue to move, but does not cut off any slices from the product (17; 127) in so doing; and
the product (17; 127) continues to be conveyed along the direction of advance (R; F1) during the blank cutting phase.

15. A method in accordance with claim 14,
characterized in that
a relative movement between the product (17; 127) and a product support (13; 137) on which the product (17; 127) lies is maintained without interruption during the blank cutting phase.

16. A method in accordance with claim 14,
characterized in that
a cutting head including the cutting blade (19; 111) and movable as a whole for establishing the spacing (D) for the blank cutting phase is moved relative to the product (17; 127) and/or at least a part of the product is moved relative to the cutting blade (19; 111) for establishing the spacing (D) for the blank cutting phase.

17. A method in accordance with claim 14,
characterized in that
a product support (13; 137) on which the product (17; 127) lies, is moved relative to the cutting blade (19; 111) for establishing the spacing (D) for the blank cutting phase, with the product being moved relative to the product support (13; 137) during the blank cutting phase.

18. A method in accordance with claim 14,
characterized in that
the product (17; 127) is conveyed along the direction of advance (R; F1) at a reduced blank cutting speed (V_{L}) during the blank cutting phase.

19. A method in accordance with claim 18,
characterized in that
the blank cutting speed (V_{L}) is selected in dependence on at least one of the duration of the blank cutting phase and the size of the spacing (D) between the cutting blade (19; 111) and the product (!7; 127).

20. A method in accordance with claim 18,
characterized in that
the blank cutting speed (V_{L}) is selected such that the product (17; 127) is conveyed during the blank cutting phase by a measure (M) which corresponds to the desired thickness of the slice to be cut off first after the blank cutting phase.

21. A method in accordance with claim 14, characterized in that an adjustment device (115) for the cutting blade (19; 111) is provided with which the cutting blade (19; 111) is movable between a cutting position and an additional function position, in particular for carrying out blank cuts,
with the cutting blade (19; 111) being coupled to the adjustment device (115) at a first region and to a guide (161) at a second region and, for adjusting the cutting blade (19; 111), its adjustment movement is fixed by an exciter movement (115) of the adjustment device (115) and by the guide (161).

22. A method in accordance with claim 14,
characterized in that
the adjustment movement of the cutting blade (19; 11) is designed so that, in the additional function position, the spacing between the cutting blade (19; 111) and a reference plane which extends parallel to a cutting plane (S; S1) defined by an edge of the cutting blade (19; 111) and which is in particular disposed on the side of the cutting blade adjacent to the product feed increases as the distance from a plane (E1) defined by a product support (13; 137) of the product feed (11; 113) increases.

23. A method in accordance with claim 14,
characterized in that;
for the adjustment of the cutting blade (19; 111), a drive unit for the cutting blade (19; 111) is adjustable which includes a drive shaft (165) and at least two rotary bearings (120, 121) for the drive shaft (165) which are spaced apart in the direction of the longitudinal axis of the drive shaft (165), with the one rotary bearing (120) being coupled to the adjustment device (115) and the other rotary bearing (121) being coupled to a guide (161).

24. A method in accordance with claim 14,
characterized in that
one of a pivot movement and a tilt movement of the cutting blade (19; 111) is carried out for adjusting the cutting blade (19; 111).
